(19) United States
(12) Patent Application Publication
(10) Pub. No.: US 2019/0371308 A1
(43) Pub. Date: Dec. 5, 2019

(54) CONTROL DEVICE, INTERACTIVE APPARATUS, AND CONTROL METHOD

(71) Applicant: SHARP KABUSHIKI KAISHA, Sakai City (JP)

(72) Inventor: SHIGENORI KINOSHITA, Sakai City (JP)

(21) Appl. No.: 16/427,686

(22) Filed: May 31, 2019

(30) Foreign Application Priority Data
Jun. 4, 2018 (JP) 2018-106974

(51) Int. Cl. G10L 15/20; G10L 13/027; G10L 15/22

(52) U.S. Cl. CPC G10L 15/20; G10L 13/027; G10L 2015/088; G10L 2015/225; G10L 15/22

(57) ABSTRACT

Provided is an interactive apparatus that controls the output of sensitive information depending on the circumstances and that is highly useful. A control device for controlling the interactive apparatus includes: a sensitive information determining section configured to determine whether or not an input/output log selected as a candidate for response content corresponding to content inputted by a user contains sensitive information; a circumstance determining section configured to determine whether or not a circumstance in which the interactive apparatus is present is a circumstance in which output of the sensitive information is appropriate; and a response content determining section configured to, if the circumstance determining section determines that the circumstance in which the interactive apparatus is present is not a circumstance in which output of the sensitive information is appropriate, determine to use, as the response content, an alternative response that does not contain the sensitive information.

This Nonprovisional application claims priority under 35 U.S.C. § 119 on Patent Application No. 2018-106974 filed in Japan on Jun. 4, 2018, the entire contents of which are hereby incorporated by reference.

### TECHNICAL FIELD

One or more embodiments of the present invention relate to an interactive apparatus that controls output of response content.

### BACKGROUND ART

An interactive apparatus that converses with a user has been known as a conventional technique. Also known is a technique which, in such an interactive apparatus, makes it possible to make an appropriate response to the input content. For example, Patent Literature 1 discloses an interactive apparatus that acquires a response sentence with use of a conversation history containing input sentences obtained by speech recognition and response sentences.

### CITATION LIST

### Patent Literature

[Patent Literature 1]

Japanese Patent Application Publication, Tokukai, No. 2006-039120 (Publication date: Feb. 9, 2006)

### SUMMARY OF INVENTION

### Technical Problem

However, according to the interactive apparatus disclosed in Patent Literature 1, if the conversation history contains sensitive information that is preferably kept secret from other people, the sensitive information may be outputted as a response at the wrong time.

An aspect of the present invention was made in view of the above issue, and an object thereof is to provide an interactive apparatus that controls the output of sensitive information depending on the circumstances arid that is highly useful.

### Solution to Problem

In order to attain the above object, a control device in accordance with an aspect of the present invention is a control device for controlling an interactive apparatus that is configured to output, in response to content inputted by a user, response content that is generated based on a past input/output history, the control device including: a sensitive information determining section configured to determine whether or not a specific input/output log selected as a candidate for the response content contains sensitive information; a circumstance determining section configured to determine whether or not a circumstance in which the interactive apparatus is present is a circumstance in which output of the sensitive information, is appropriate; and a response content determining section configured to determine the response content, the response content determining section being configured to, if the circumstance determining section determines that the circumstance in which the interactive apparatus is present is not a circumstance in which output of the sensitive information is appropriate, determine to use, as the response content, an alternative response that does not contain the sensitive information.

An interactive apparatus in accordance with another aspect of the present invention is an interactive apparatus configured to output, in response to content inputted by a user, response content that is generated based on a past input/output history, the interactive apparatus including: at least one input device; at least one output device; at least one storage device; and at least one control device, the at least one control device being configured to carry out a process including a sensitive information determining step including determining whether or not a specific input/output log selected as a candidate for the response content contains sensitive information, a circumstance determining step including determining whether or not a circumstance in which the interactive apparatus is present is a circumstance in which output of the sensitive information, is appropriate, and a response content determining step including determining the response content, the response content determining step including, if it is determined in the circumstance determining step that the circumstance in which the interactive apparatus is present is not a circumstance in which output of the sensitive information is appropriate, determining to use, as the response content, an alternative response that does not contain the sensitive information.

A control method in accordance with a further aspect of the present invention is a method of controlling an interactive apparatus that is configured to output, in response to content inputted by a user, response content that is generated based on a past input/output history, the method including: a sensitive information determining step including determining whether or not a specific input/output log selected as a candidate for the response content contains sensitive information; a circumstance determining step including determining whether or not a circumstance in which the interactive apparatus is present is a circumstance in which output of the sensitive information is appropriate; and a response content determining step including determining the response content, the response content determining step including, if it is determined in the circumstance determining step that the circumstance in which the interactive apparatus is present is not a circumstance in which output of the sensitive information is appropriate, determining to use, as the response content, an alternative response that does not contain the sensitive information.

### Advantageous Effects of Invention

An aspect of the present invention provides an effect of making it possible to provide an interactive apparatus that controls output of sensitive information depending on the circumstances and that is highly useful.

### BRIEF DESCRIPTION OF DRAWINGS

FIG. 1 is a block diagram illustrating an example of a configuration of main parts of an interactive apparatus in accordance with. Embodiment 1 of the present invention.

FIG. 2 schematically illustrates examples of flows of determination, by the interactive apparatus in accordance with Embodiment 1 of the present invention, of response content based on the circumstances. a-1 to a-4 of FIG. 2 illustrate a previous conversation, and b-1 to b-4 of FIG. 2 illustrate how the interactive apparatus operates in a case where, after the conversation of a-1 to a-4 of FIG. 2, a log that contains sensitive information is selected as a response candidate under a circumstance in which a person other than the user is present. c-1 to c-4 of FIG. 2 illustrate how the interactive apparatus operates in a case where, after the conversation of a-1 to a-4 of FIG. 2, a log that contains sensitive information is selected as a response candidate under a circumstance in which no other persons other than the user are present.

FIG. 3 shows examples of an input/output history that correspond to a-1 to a-4, b-1 to b-4, and c-1 to c-4 of FIG. 2, respectively. Table 1 of FIG. 3 shows the details of the input/output history immediately after the conversation of a-1 to a-4 of FIG. 2. Table 2 of FIG. 3 shows the details of the input/output history immediately after the conversation of b-1 to b-4 of FIG. 2. Table 3 of FIG. 3 shows the details of the input/output history immediately after the conversation of c-1 to c-4 of FIG. 2.

FIG. 4 is a flowchart showing an example of a flow of a process carried out by the interactive apparatus in accordance with Embodiment 1 of the present invention.

### DESCRIPTION OF EMBODIMENTS

### Embodiment 1

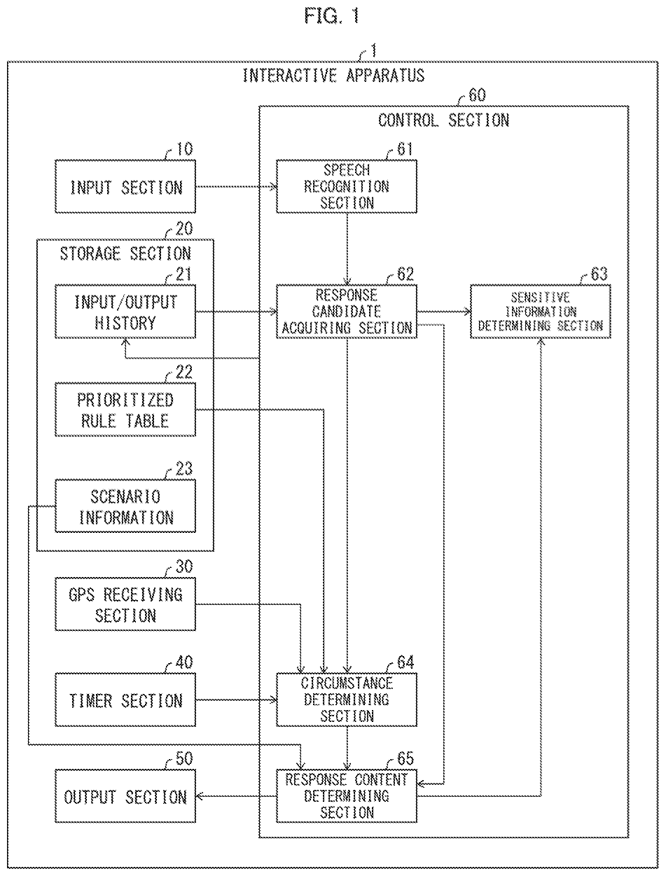

The following description will discuss an embodiment of the present invention in detail with reference to FIGS. 1 to 4.

(Configuration of Interactive Apparatus)

The following discusses a configuration of an interactive apparatus 1 in accordance with Embodiment 1 with reference to FIG. 1. FIG. 1 is a block diagram illustrating an example of a configuration of main parts of the interactive apparatus 1.

The interactive apparatus 1 is capable of outputting, in response to content inputted by a user, response content that is generated based on a past input/output history. More specifically, upon receipt of an input from a user, the interactive apparatus 1 acquires, from the past input/output history, a response candidate (candidate for response content) that corresponds to the input. If the acquired response candidate contains no sensitive information, the interactive apparatus 1 outputs response content based on the response candidate. On the contrary, if the acquired response candidate contains sensitive information, the interactive apparatus 1 determines whether or not the circumstance in which the interactive apparatus 1 is present is a circumstance in which output of the sensitive information is appropriate. If it is determined that the interactive apparatus 1 is in a circumstance in which output of the sensitive information is appropriate, the interactive apparatus 1 outputs response content based on the response candidate. If it is determined that the interactive apparatus 1 is in a circumstance in which output of the sensitive information is not appropriate, the interactive apparatus 1 outputs, as response content, an alternative response that contains no sensitive information. As used herein, the term “sensitive information” refers to information unauthorized disclosure of which could lead to some problem, such as personal information of the user.

The interactive apparatus 1 includes an input section 10, a storage section 20, a GPS receiving section 30, a timer section 40, an output section 50, and a control section 60. The storage section 20 includes an input/output history 21, a prioritized rule table 22, and scenario information 23. The control section 60 includes a speech recognition section 61, a response candidate acquiring section 62, a sensitive information determining section 63, a circumstance determining section 64, and a response content determining section 65.

The input section 10 is, for example, a microphone that receives an input of a user's speech, and serves as an input device that sends, to the speech recognition section 61, the received speech as voice data. The input section 10 may have any configuration, provided that the input section 10 is capable of receiving an input of a user's speech. For example, an interface such as a button may be provided in addition to the microphone.

The storage section 20 serves as a storage device for storing various kinds of information for use in the interactive apparatus 1. The storage section 20 may further include, for example, dictionary information (not illustrated) or the like that manages information to be treated as sensitive information.

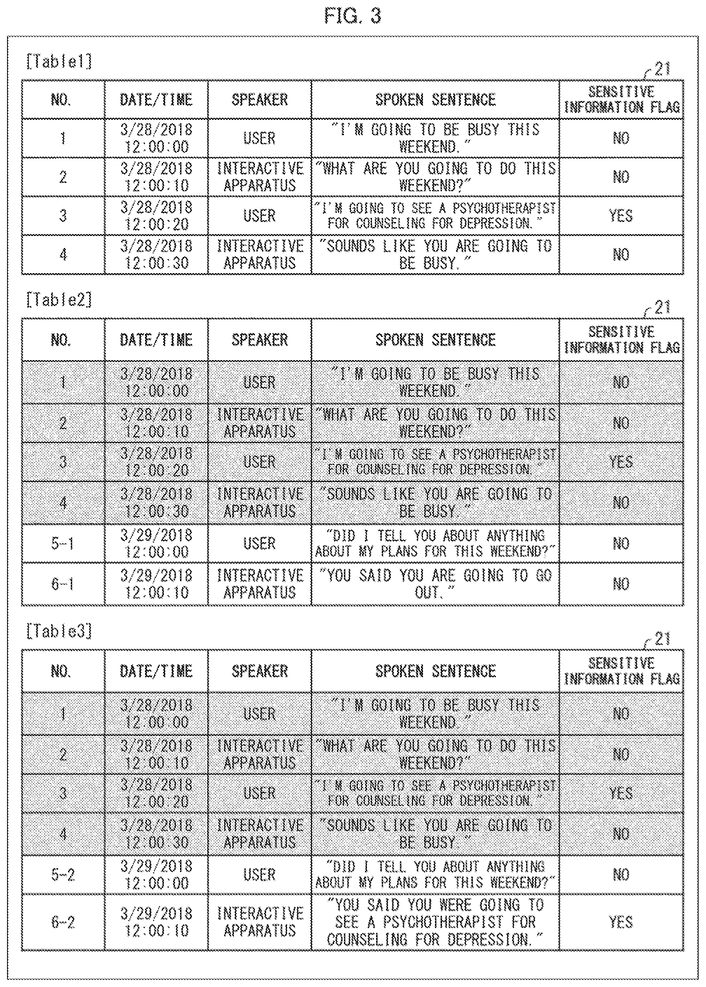

The input/output history 21 has, stored therein, one or more logs of speeches inputted by a user into the interactive apparatus 1 and/or response content outputted by the interactive apparatus 1 to the user. The input/output history 21 is configured to have new logs registered therewith by the control section 60, and the logs in the input/output history 21 are read by the response candidate acquiring section 62. Specific examples of the input/output history 21 will be described later with reference to Tables 1 to 3 of FIG. 3.

The prioritized rule table 22 is reference information that is referred to by the circumstance determining section 64 to determine whether or not the circumstance in which the interactive apparatus 1 is present is a circumstance in which output of sensitive information is appropriate. The following are three examples of the reference information; ever, needless to say, these examples do not imply any limitation. The first is a rule such that, if the sound received at the input section 10 contains a voice of a person other than the user, it is determined that the interactive apparatus 1 is in a circumstance in which output of sensitive information is not appropriate. The second is a rule such that, if GPS information received by the GPS receiving section 30 indicates that the current location of the interactive apparatus 1 matches a private space such as the user's home, it is determined that the interactive apparatus 1 is in a circumstance in which output of sensitive information is appropriate. The third is a rule such that, if the current date and time acquired by the timer section 40 indicate night and the interactive apparatus 1 is assumed to be located at the user's home, it is determined that the interactive apparatus 1 is in a circumstance in which output of sensitive information is appropriate.

The scenario information 23 is reference information in which response content that is to be outputted in response to input content is defined. The scenario information 23 is referred to by the response content determining section 65 if (i) the response candidate acquiring section 62 fails to acquire any response candidate that corresponds to the input content and/or (ii) the circumstance determining section 64 determines that the interactive apparatus 1 is in a circumstance in which output of sensitive information is not appropriate.

The GPS receiving section 30 receives information related to the current location of the interactive apparatus 1 in accordance with an instruction from the control section 60, and sends the information to the circumstance determining section 64. The GPS receiving section 30 may have any configuration, provided that the GPS receiving section 30 is capable of sending the information related to the current location of the interactive apparatus 1 to the circumstance determining section 64. The GPS receiving section 30 may be configured to receive GPS information from a GPS satellite. The following arrangement may be employed: the GPS receiving section 30 is capable of connecting with, for example, a Wi-Fi (registered trademark) environment; and, if it is detected that the GPS receiving section 30 is connected to the Wi-Fi environment at the user's home, the GPS receiving section 30 sends, to the circumstance determining section 64, information indicating that the interactive apparatus 1 is located at the user's home.

The timer section 40 acquires information about the current date and time in accordance with an instruction from the control section 60, and sends the information to the circumstance determining section 64.

The output section 50 serves as an output device that outputs response content which corresponds to content of the user's speech received by the input section 10. The output section 50 may have any configuration, provided that the output section 50 includes a speaker via which the response content is outputted in a sound form. The output section 50 may include, for example, a display via which an image or the like is outputted in combination with the sound.

The control section 60 serves as a control device that carries out an overall control of the sections in the interactive apparatus 1. The control section 60 is configured such that, if the content inputted by the user and the response content outputted through the output section 50 by the interactive apparatus 1 contain sensitive information, the control section 60 adds information indicating that sensitive information is contained, and registers, with the input/output history 21, the input content and the response content that have added thereto the information indicating that sensitive information is contained.

Upon receipt of the voice data from the input section 10, the speech recognition section 61 carries out speech recognition of the voice data, and generates text data indicative of content of the user's speech. A method by which the recognition section 61 carries out speech recognition is not limited to a particular kind, and any existing method may be used to carry out the speech recognition. The speech recognition section 61 sends the generated text data to the response candidate acquiring section 62.

The response candidate acquiring section 62 acquires, from the input/output history 21, a candidate for response content that corresponds to the input content. Specifically, the response candidate acquiring section 62 selects, from the input/output history 21, a candidate for response content that corresponds to the text data received from the speech recognition section 61. If no appropriate candidates are found, the response candidate acquiring section 62 notifies the response content determining section 65 that no appropriate candidates have been found. On the contrary, if an appropriate candidate is found, the response candidate acquiring section 62 sends the candidate to the circumstance determining section 64.

Upon selection by the response candidate acquiring section 62 of the candidate for response content from the input/output history 21, the sensitive information determining section 63 determines whether or not the selected input/output log contains sensitive information, in accordance with an instruction from the control section 60. The sensitive information determining section 63 also determines, after the response content determining section 65 outputs the response content via the output section 50, whether or not the response content contains sensitive information, in accordance with an instruction from the control section 60. The sensitive information determining section 63 may, for example, refer to the dictionary information (not illustrated) or the like included in the storage section 20 to thereby carry out the determination. The sensitive information determining section 63 sends the result of the determination to the control section 60.

The circumstance determining section 64, upon receipt of the candidate for response content from the response candidate acquiring section 62 and receipt of the result of the determination of whether or riot the candidate contains sensitive information, determines whether or not the circumstance in which the interactive apparatus 1 is present is a circumstance in which output of response content that contains sensitive information is appropriate. The circumstance determining section 64 sends the result of the determination to the response content determining section 65. Specifically, the circumstance determining section 64 carries out the determination of whether or not the circumstance in which the interactive apparatus 1 is present is a circumstance in which output of sensitive information is appropriate, in the following manner: based on at least one of (i) location information of the interactive apparatus 1 received by the GPS receiving section 30, an ambient sound contained in the sound received by the input section 10, and (iii) information about the current date and time acquired from the timer section 40, the circumstance determining section 64 determines whether any of the condition(s) that should be met in order that the interaction apparatus 1 is determined to be in a circumstance in which output of sensitive information is appropriate, in the prioritized rule table 22, is satisfied.

The response content determining section 65 determines response content that is to be outputted as a response to the content inputted by the user via the input section 10, and outputs the response content via the output section 50. Specifically, if the response candidate acquiring section 62 finds no appropriate candidates for response content that corresponds to the input content, the response content determining section 65 determines response content by referring to the scenario information 23 arid outputs the response content via the output section 50. If the response candidate acquiring section 62 finds an appropriate candidate and the sensitive information determining section determines that the candidate contains no sensitive information or if the sensitive information determining section 63 determines that the candidate contains sensitive information and the circumstance determining section 64 determines that the interactive apparatus 1 is in a circumstance in which output of sensitive information is appropriate, the response content determining section 65 determines response content based on that candidate and outputs the response content via the output section 50. If the response candidate acquiring section 62 finds an appropriate candidate, the sensitive information determining section 63 determines that the candidate contains sensitive information, and the circumstance determining section 64 determines that the interactive apparatus 1 is in a circumstance in which output of sensitive information is not appropriate, the response content determining section 65 determines to use an alternative response as response content by referring to the scenario information 23, and outputs the alternative response via the output section 50.

(Specific Example of Determination of Response Content Based on Circumstances)

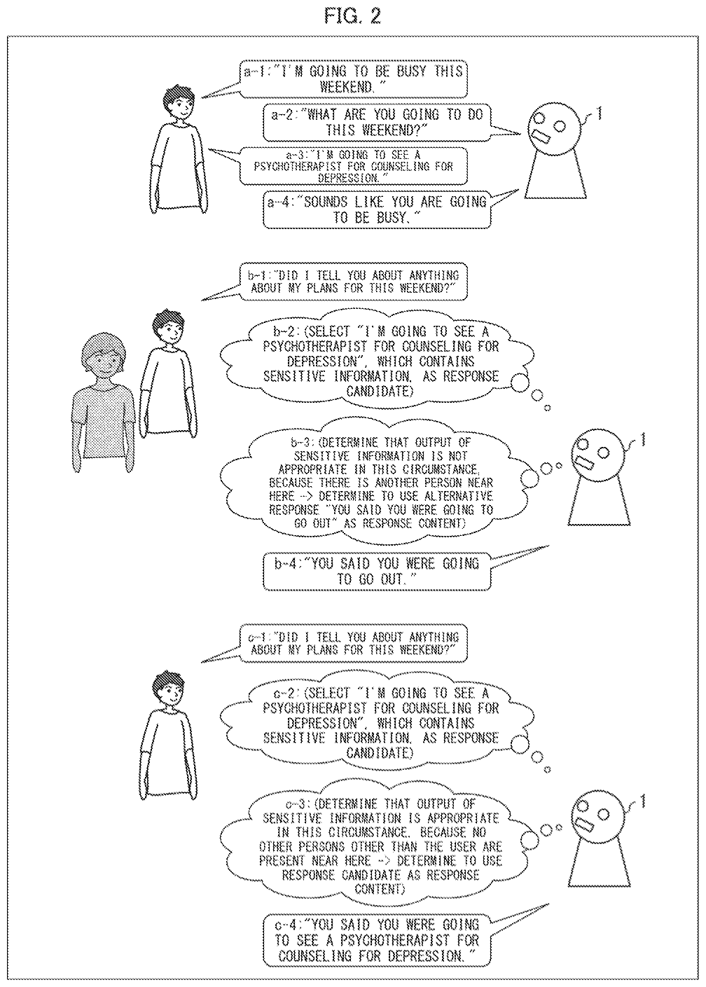

The following description will discuss a specific example of how the interactive apparatus 1 in accordance with Embodiment 1 determines response content based on the circumstances, with reference to FIG. 2 and FIG. 3. FIG. 2 schematically illustrates examples of flows of determination, by the interactive apparatus 1, of response content based on the circumstances. a-1 to a-4 of FIG. 2 illustrate a previous conversation, and b-1 to b-4 of FIG. 2 illustrate how the interactive apparatus 1 operates in a case where, after the conversation of a-1 to a-4 of FIG. 2, a specific input/output log that contains sensitive information is selected as a response candidate under a circumstance in which a person other than the user is present. c-1 to c-4 of FIG. 2 illustrate how the interactive apparatus 1 operates in a case where, after the conversation of a-1 to a-4 of FIG. 2, a specific input/output log that contains sensitive information is selected as a response candidate under a circumstance in which no other persons other than the user are present. FIG. 3 shows examples of the input/output history 21 that correspond to a-1 to a-4, b-1 to b-4, and c-1 to c-4 of FIG. 2, respectively. Table 1 of FIG. 3 shows the details of the input/output history 21 immediately after the conversation of a-1 to a-4 of FIG. 2. Table 2 of FIG. 3 shows the details of the input/output history 21 immediately after the conversation of b-1 to b-4 of FIG. 2. Table 3 of FIG. 3 shows the details of the input/output history 21 immediately after the conversation of c-1 to c-4 of FIG. 2.

In. FIG. 2, the reference numerals a-1 to a-4, b-1 to b-4, and c-1 to c-4 indicate the order in which processes are carried out in the conversations. In each of Tables 1 to 3 of FIG. 3, the input/output history 21 includes five columns: a “NO.” column, a “DATE/TIME” column, a “SPEAKER” column, a “SPOKEN SENTENCE column, and a “SENSITIVE INFORMATION FLAG” column. The numbers in the “NO.” column indicate the order in which logs sere registered, and each data piece in the “DATE/TIME” column indicates the date and time at which a corresponding record was registered. Each data piece in the “SPEAKER” column indicates which of the user or the interactive apparatus 1 spoke the content in the “SPOKEN SENTENCE” column, and each data piece in the “SPOKEN SENTENCE” column indicates the actually spoken content. Each data piece in the “SENSITIVE INFORMATION FLAG” column indicates whether or not corresponding content in the “SPOKEN SENTENCE” column contains sensitive information.

According to Table 1 of FIG. 3, for example, “YES” in the “SENSITIVE INFORMATION FLAG” column of the record whose number in the “NO.” column is “3” indicates that the speech content “I'M GOING TO SEE A PSYCHOTHERAPIST FOR COUNSELING FOR DEPRESSION” in the “SPOKEN SENTENCE” column of that record contains sensitive information. Note that, in the following description, “PSYCHOTHERAPIST” and “DEPRESSION” are each sensitive information, and a record that contains any of such character strings in the “SPOKEN SENTENCE” column has “YES” registered therewith in the “SENSITIVE INFORMATION FLAG” column. Further note that, for convenience of description, the following description is based on the assumption that the circumstance determining section 64 determines that the circumstance in which the interactive apparatus 1 is present is not a circumstance in which output of sensitive information is appropriate if a person other than the user is present near the interactive apparatus 1, whereas the circumstance determining section 64 determines that the circumstance in which the interactive apparatus 1 is present is a circumstance in which output of sensitive information is appropriate if no other persons are present near the interactive apparatus 1.

The following description will discuss a previous conversation carried out between the user and the interactive apparatus 1, with reference to a-1 to a-4 of FIG. 2 and Table 1 of FIG. 3. It should be noted that, at the point in time at which the previous conversation illustrated in a-1 to a-4 of FIG. 2 was started, no logs were present in the input/output history 21.

First, the user says “I'M GOING TO BE BUSY THIS WEEKEND” (see a-1). The interactive apparatus 1 receives this speech at the input section 10, and then generates text data “I'M GOING TO BE BUSY THIS WEEKEND” that corresponds to the speech through use of the speech recognition section 61, and then registers a log related to the speech with the input/output history 21. Specifically, the interactive apparatus 1 registers the log as a record whose number in the “NO.” column is “1”, as shown in Table 1 of FIG. 3.

Next, the interactive apparatus 1 outputs “WHAT ARE YOU GOING TO DO THIS WEEKEND?” (see a-2) as response content that corresponds to the input content “I'M GOING TO BE BUSY THIS WEEKEND” (see a-1). The interactive apparatus 1 first selects a candidate for response content from the input/output history 21. Currently, the input/output history 21 only has the record whose number in the “NO.” column is “1”, and therefore the interactive apparatus 1 determines that no candidates for response content have been found, and determines to use “WHAT ARE YOU GOING TO DO THIS WEEKEND?” as response content based on the scenario information 23. After outputting the response (a-2), the interactive apparatus 1 registers a record whose number in the “NO.” column is “2”, as shown in Table 1 of FIG. 3.

In response to the response a-2, the user says “I'M GOING TO SEE A PSYCHOTHERAPIST FOR COUNSELING FOR DEPRESSION” (see a-3). Then, the interactive apparatus 1 determines to use “SOUNDS LIKE YOU ARE GOING TO BE BUSY” as response content in the same manner as in the case of a-1, and outputs the response content (see a-4). The interactive apparatus 1 registers a record whose number in the “NO.” column is “3” and a record whose number in the “NO.” column is “4” as shown in Table 1 of FIG. 3, in accordance with the user's speech and the response that the interactive apparatus 1 made. The speech “I'M GOING TO SEE A PSYCHOTHERAPIST FOR COUNSELING FOR DEPRESSION” (a-3) contains “PSYCHOTHERAPIST” and “DEPRESSION” which are each sensitive information, and therefore the interactive apparatus 1 registers the record whose number in the “NO.” column is “3” such that “YES” is indicated in the “SENSITIVE INFORMATION FLAG” column.

In this way, the interactive apparatus 1 is, if no appropriate response candidates are found, capable of determining response content that corresponds to a speech of the user based on the scenario information 23 and outputting the response content. The interactive apparatus 1 is also capable of registering, with the input/output history 21, the input content obtained from the user's speech and the response content outputted by the interactive apparatus 1.

The following description discusses, with reference to b-1 to b-4 of FIG. 2 and Table 2 of FIG. 3, how the interactive apparatus 1 operates in a case where a specific input/output log that contains sensitive information is selected as a response candidate under a circumstance in which another person is present near the interactive apparatus 1 after the previous conversation shown in a-1 to a-4 of FIG. 2.

First, the user says “DID I TELL YOU ABOUT ANYTHING ABOUT MY PLANS FOR THIS WEEKEND?” (see b-1). Then, the interactive apparatus 1 registers an input log about this speech as a record whose number in the “NO.” column is “5-1”, as shown in Table 2 of FIG. 3. Then, the interactive apparatus 1 selects, as a candidate for response content that corresponds to the input content b-1, a record whose data in the “SPEAKER” column is “USER” and which was registered after the registration of the record whose data in the “SPEAKER” column is “INTERACTIVE APPARATUS” and whose data in the “SPOKEN SENTENCE” column contains “THIS WEEKEND”, from the input/output history 21. That is, the interactive apparatus 1 selects, as a candidate for response content, the record whose number in the “NO.” column is “3” and which contains the sensitive information “PSYCHOTHERAPIST” and the sensitive information “DEPRESSION” in the “SPOKEN SENTENCE” column (see b-2).

After the selection b-2, the interactive apparatus 1 determines whether or not the circumstance in which the interactive apparatus 1 is present is a circumstance in which output of the sensitive information is appropriate. In b-1 to b-4 of FIG. 2, there is another person near the user, and therefore the interactive apparatus 1 determines that the circumstance in which the interactive apparatus 1 is present is not a circumstance in which output of sensitive information is appropriate. Then, the interactive apparatus 1 refers to the scenario information 23, and thereby determines to use the alternative response “YOU SAID YOU WERE GOING TO GO OUT” as response content (see b-3). Note that the alternative response may be a response that is suitable for the candidate for response content. Specifically, the alternative response “YOU SAID YOU WERE GOING TO GO OUT” may be determined from the fact that the candidate for response content “I'M GOING TO SEE A PSYCHOTHERAPIST FOR COUNSELING FOR DEPRESSION indicates that the user is going to go out.

After the determination b-3, the interactive apparatus 1 outputs the alternative response “YOU SAID YOU WERE GOING TO GO OUT” that has been determined as the response content (see h-4), and registers, with the input/output history 21, a log of the output as a record whose number in the “NO.” column is “6-1”.

In this way, if a specific input/output log that contains sensitive information is selected from the input/output history 21 as a candidate for response content that corresponds to the input content and the circumstance in which the interactive apparatus 1 is present is not circumstance in which output of sensitive information is appropriate, the interactive apparatus 1 is capable of determining to use an alternative response as response content and outputting the alternative response. This makes it possible to prevent the leakage of sensitive information.

The following description discusses, with reference to c-1 to c-4 of FIG. 2 and Table 3 of FIG. 3, how the interactive apparatus 1 operates in a case where a specific input/output log that contains sensitive information is selected as a response candidate under a circumstance in which no other persons are present near the interactive apparatus 1 after the previous conversation shown in a-1 to a-4 of FIG. 2.

First, the user says “DID I TELL YOU ABOUT ANYTHING ABOUT MY PLANS FOR THIS WEEKEND?” (see c-1). Then, the interactive apparatus 1 registers an input log about this speech as a record whose number in the “NO.” column is “5-2” as shown in Table 3 of FIG. 3, in the same manner as in the case of b-1 to b-4 of FIG. 2. Then, the interactive apparatus 1 selects, as a candidate for response content, the record whose number in the “NO.” column is “3” and whose data in the “SPOKEN SENTENCE” contains the sensitive information “PSYCHOTHERAPIST” and the sensitive information “DEPRESSION” (see c-2).

After the selection c-2, the interactive apparatus 1 determines whether or not the circumstance in which the interactive apparatus 1 is present is a circumstance in which output of sensitive information is appropriate. In c-1 to c-4 of FIG. 2, no other persons are present near the user, and therefore the interactive apparatus 1 determines that the circumstance in which the interactive apparatus 1 is present is a circumstance in which output of sensitive information is appropriate. Then, the interactive apparatus 1 determines to use the candidate for response content as response content (see c-3).

After the determination c-3, the interactive apparatus 1 generates the response content “YOU SAID YOU WERE GOING TO SEE A PSYCHOTHERAPIST FOR COUNSELING FOR DEPRESSION” based on the candidate for response content “I'M GOING TO SEE A PSYCHOTHERAPIST FOR COUNSELING FOR DEPRESSION” that has been determined as the response content. The interactive apparatus 1 outputs the generated response content, arid registers, with the input/output history 21, a log of the output as a record whose number in the “NO.” column is “6-2”.

In this way, if a specific input/output log that contains sensitive information is selected from the input/output history 21 as a candidate for response content that corresponds to the input content and the circumstance in which the interactive apparatus 1 is present is a circumstance in which output of sensitive information is appropriate, the interactive apparatus 1 is capable of generating response content based on the candidate and outputting the response content. This makes it possible to present the sensitive information to the user as long as the interactive apparatus 1 is in a circumstance in which output of the sensitive information is appropriate.

(Flow of Process)

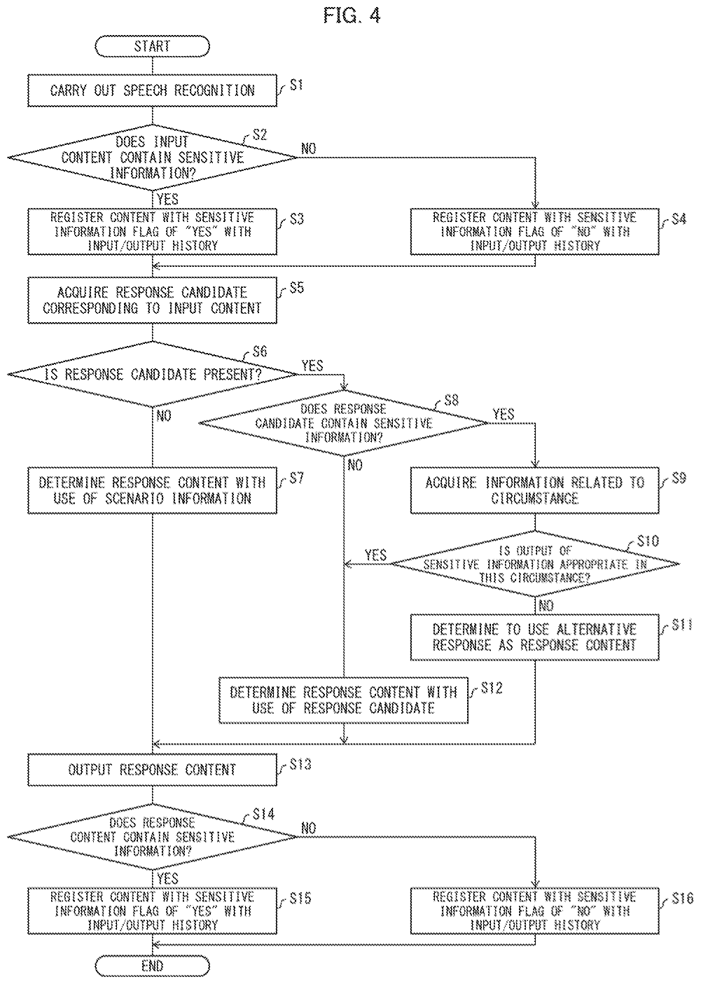

The following description will discuss a flow of a process carried out by the interactive apparatus 1 in accordance with Embodiment 1 with reference to FIG. 4. FIG. 4 is a flowchart showing an example of the flow of the process carried out by the interactive apparatus 1.

First, the interactive apparatus 1 receives, at the input section 10, an input of a sound of a speech of a user, and generates text data by carrying out speech recognition of voice data (data of the sound) through use of the speech recognition section 61 (S1). Next, the sensitive information determining section 63 determines whether or not the text data generated in S1, which is input content, contains sensitive information (S2: sensitive information determining step). If it is determined that the text data contains sensitive information (YES in S2), the control section 60 registers, with the input/output history 21, a record whose sensitive information flag is “YES” (S3). Then, the process proceeds to S5. On the contrary, if it is determined that the text data contains no sensitive information (NO in S2), the control section 60 registers, with the input/output history 21, a record whose sensitive information flag is NO (S4). Then, the process proceeds to S5.

In S5, the response candidate acquiring section 62 acquires, from the input/output history 21, a candidate for response content that corresponds to the input content (S5). The response candidate acquiring section 62 further determines whether or not the candidate for response content successfully acquired in S5 is present (S6). If it is determined that the candidate is not present (NO in S6), the response candidate acquiring section 62 notifies the response content determining section 65 that the candidate is not present. Then, the response content determining section 65 determines response content that corresponds to the input content with the use of the scenario information 23 (S7: response content determining step). Then, the process proceeds to S13.

If it is determined in S6 that the candidate for response content is present (YES in S6), the response candidate acquiring section 62 further determines whether or not the candidate for response content contains sensitive information (S8). If it is determined that the candidate contains sensitive information (YES in S8), the circumstance determining section 64 acquires, with the use of the GPS receiving section 30 or the like, information related to a circumstance in which the interactive apparatus 1 is present (S9). Then, the circumstance determining section 64 determines whether or not the circumstance in which the interactive apparatus 1 is present is a circumstance in which output of sensitive information is appropriate (S10: circumstance determining step). If it is determined that the circumstance in which the interactive apparatus 1 is present is not a circumstance in which output of sensitive information is appropriate (NO in S10), the circumstance determining section 64 sends the result of the determination to the response content determining section 65. The response content determining section 65 generates an alternative response based on the received result of determination with the use of the scenario information 23, and determines to use the alternative response as response content (S11: response content determining steps). Then the process proceeds to S13.

On the contrary, if it is determined by the response candidate acquiring section 62 in S8 that the candidate contains no sensitive information (NO in S8) or if it is determined by the circumstance determining section 64 in S10 that the circumstance in which the interactive apparatus 1 is present is a circumstance in which output of sensitive information is appropriate (YES in S10), the response content determining section 65 determines response content with the use of the response candidate acquired in S5 (S12: response content determining step). Then, the process proceeds to S13.

In S13, the response content determining section 65 outputs, through the output section 50, the response content determined in S7, S11, or S12 (S13). Then, the control section 60 determines whether or not the response content outputted in S13 contains sensitive information, through use of the sensitive information determining section 63 (S14: sensitive information determining step). If it is determined that the response content contains sensitive information (YES in S14), the control section 60 registers, with the input/output history 21, a record whose sensitive information flag is “YES” (S15), and then the process ends. On the contrary, if it is determined that the response content contains no sensitive information (NO in S15), the control section 60 registers, with the input/output history 21, a record whose sensitive information flag is “NO” (S16), and then the process ends.

Through the so-far described process, the interactive apparatus 1 in accordance with Embodiment 1 is capable of making a response based on a past input/output history when conversing with the user. The interactive apparatus 1 is further capable of, if a candidate for response content contains sensitive information arid the circumstance in which the interactive apparatus 1 is present is not a circumstance in which output of sensitive information is appropriate, making a response using an alternative response that does not contain the sensitive information. This makes it possible, if, for example, a person other than the user is present near the interactive apparatus 1 and the user does not want the person to hear sensitive information such as personal information of the user, to cause the interactive apparatus 1 to output an alternative response. This provides an effect of making it possible to provide an interactive apparatus that controls the output of sensitive information depending on the circumstances and that is highly useful.

It should be noted that the alternative response “YOU SAID YOU WERE GOING TO GO OUT” used in the description with reference to b-1 to b-4 of FIG. 2 corresponds to a candidate for response content containing sensitive information, that is, “I'M GOING TO SEE A PSYCHOTHERAPIST FOR COUNSELING FOR DEPRESSION”; however, the alternative response may have any content. For example, the interactive apparatus 1 may be configured to output a sentence that does not contain any content of the input/output history 21, such as “DO YOU HAVE TIME TO TALK NOW?” as an alternative response.

[Variations]

In Embodiment 1 , the interactive apparatus 1 is configured such that, if the circumstance in which the interactive apparatus 1 is present is not a circumstance in which output of sensitive information is appropriate, the interactive apparatus 1 makes a response with the use of an alternative response that does not contain the sensitive information. Note, however, that the following arrangement may be employed, for example: in a case where the output section 50 of the interactive apparatus 1 includes a plurality of output means such as a combination of a speaker and a display, the interactive apparatus 1 outputs an alternative response through the speaker and outputs response content that contains sensitive information through the display. That is, the response content determining section 65 may be configured such that, in a case where the interactive apparatus 1 includes a plurality of elements serving as the output section 50, the response content determining section 65 determines to use different kinds of response content for the respective elements. Specifically, the response content determining section 65 may be configured to determine to use an alternative response as response content for the speaker and determine to use response content that contains sensitive information for the display, independently of each other. In this arrangement, the interactive apparatus 1 may be configured to orient the display in a direction that is viewable only by the user with the use of a driving section (not illustrated).

[Software Implementation Example]

Control blocks of the interactive apparatus 1 (particularly, the sensitive information determining section 63, the circumstance determining section 64, and the response content determining section 65) can be realized by a logic circuit (hardware) provided in an integrated circuit (IC chip) or the like or can be alternatively realized by software.

In the latter case, the interactive apparatus 1 includes a computer that executes instructions of a program that is software realizing the foregoing functions. The computer, for example, includes at least one processor (control device) and at least one computer-readable storage medium storing the program. An object of the present invention can be achieved by the processor of the computer reading and executing the program stored in the storage medium. Examples of the processor encompass a central processing unit (CPU). Examples of the storage medium encompass a “non-transitory tangible medium” such as a read only memory (ROM), a tape, a disk, a card, a semiconductor memory, and a programmable logic circuit. The computer may further include a random access memory (RAM) or the like in which the program is loaded. Further, the program may be supplied to or made available to the computer via any transmission medium (such as a communication network and a broadcast wave) which allows the program to be transmitted. Note that an aspect of the present invention can also be achieved in the form of a computer data signal in which the program is embodied via electronic transmission and which is embedded in a carrier wave.

[Recap]

A control device (control section 60) in accordance with Aspect 1 of the present invention is a control device for controlling an interactive apparatus (1) that is configured to output, in response to content inputted by a user, response content that is generated based on a past input/output history (21), the control device including: a sensitive information determining section (63) configured to determine whether or not a specific input/output log selected as a candidate for the response content contains sensitive information; a circumstance determining section (64) configured to determine whether or not a circumstance in which the interactive apparatus is present is a circumstance in which output of the sensitive information is appropriate; and a response content determining section (65) configured to determine the response content, the response content determining section being configured to, if the circumstance determining section determines that the circumstance in which the interactive apparatus is present is not a circumstance in which output of the sensitive information is appropriate, determine to use, as the response content, an alternative response that does not contain the sensitive information.

According to the above arrangement, the interactive apparatus is capable of making a response based on a past input/output history when conversing with the user. The interactive apparatus is further capable of, if a candidate for response content contains sensitive information and the circumstance in which the interactive apparatus is present is not a circumstance in which output of sensitive information is appropriate, making a response using an alternative response that does not contain the sensitive information. This makes it possible, if, for example, a person other than the user is present near the interactive apparatus and the user does not want the person to hear sensitive information such as personal information of the user, to cause the interactive apparatus to output an alternative response. This provides an effect of making it possible to provide an interactive apparatus that controls the output of sensitive information depending on the circumstances and that is highly useful.

A control device (control section 60) in accordance with Aspect 2 of the present invention may be arranged such that, in Aspect 1, the circumstance determining section (64) is configured to determine whether or not the circumstance in which the interactive apparatus (1) is present is a circumstance in which output of the sensitive information is appropriate based on at least one of a location of the interactive apparatus (1), an ambient sound around the interactive apparatus (1), arid a current date and time.

According to the above arrangement, the interactive apparatus is capable of determining whether or not the interactive apparatus is in a circumstance in which output of sensitive information is appropriate, on the basis of, for example, the location information of the interactive apparatus. This makes it possible for the interactive apparatus to, if the interactive apparatus determines from the location information or the like that the interactive apparatus is located at the user's home, determine that the interactive apparatus is in a circumstance in which output of sensitive information is appropriate and output response content that contains the sensitive information.

A control device (control section 60) in accordance with Aspect 3 of the present invention may be arranged such that, in Aspect 1 or 2, the alternative response does not contain any content of the past input/output history (21).

According to the above arrangement, the interactive apparatus is capable of, if the circumstance in which the interactive apparatus is present is not a circumstance in which output of sensitive information is appropriate, outputting an alternative response that does not contain any content of the past input/output history. This makes it possible, for example, to output natural response content that is not limited to the content of the past input/output history.

A control device (control section 60) in accordance with Aspect 4 of the present invention may be arranged such that, in any of Aspects 1 to 3, if the content inputted by the user and the response content outputted by the interactive apparatus (1) contain the sensitive information, the content inputted by the user and the response content outputted by the interactive apparatus (1) are provided with information indicating that the sensitive information is contained, and are registered as input/output logs in the past input/output history (21).

According to the above arrangement, the interactive apparatus is capable of, in regard to an input/output log that contains sensitive information, registering the input/output log that has added thereto information indicating that sensitive information is contained. This makes it possible, for example, to unfailingly determine whether or not a specific input/output log selected as a candidate for response content contains sensitive information.

An interactive apparatus (1) in accordance with Aspect 5 of the present invention is an interactive apparatus configured to output, in response to content inputted by a user, response content that is generated based on a past input/output history (21), the interactive apparatus including: at least one input device (input section 10); at least one output device (output section 50); at least one storage device (storage section 20); and at least one control device (control section 60), the at least one control device being configured to carry out a process including a sensitive information determining step (sensitive information determining section 63) including determining whether or not a specific input/output log selected as a candidate for the response content contains sensitive information, a circumstance determining step (circumstance determining section 64) including determining whether or not a circumstance in which the interacts re apparatus (1) is present is a circumstance in which output of the sensitive information is appropriate, and a response content determining step (response content determining section 65) including determining the response content, the response content determining step including, if it is determined in the circumstance determining step that the circumstance in which the interactive apparatus (1) is present is not a circumstance in which output of the sensitive information is appropriate, determining to use, as the response content, an alternative response that does not contain the sensitive information. This arrangement brings about the same effects as those provided by Aspect 1.

A control method in accordance with Aspect 6 of the present invention is a method of controlling an interactive apparatus (1) that is configured to output, in response to content inputted by a user, response content that is generated based on a past input/output history (21), the method including: a sensitive information determining step (S2, S14) including determining whether or not a specific input/output log selected as a candidate for the response content contains sensitive information; a circumstance determining step (S10) including determining whether or not a circumstance in which the interactive apparatus (1) is present is a circumstance in which output of the sensitive information is appropriate; and a response content determining step (S7, S11, S12) including determining the response content, the response content determining step including, if it is determined in the circumstance determining step that the circumstance in which the interactive apparatus (1) is present is not a circumstance in which output of the sensitive information is appropriate, determining to use, as the response content, an alternative response that does not contain the sensitive information. This arrangement brings about the same effects as those provided by Aspect 1.

The interactive apparatus according to the foregoing embodiments of the present invention may be realized by a computer. In this case, the present invention encompasses: a control program for the interactive apparatus which program causes a computer to operate as the foregoing sections software elements) of the interactive apparatus so that the interactive apparatus can be realized by the computer; and a computer-readable storage medium storing the control program therein.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1 interactive apparatus

10 input section (input device)

20 storage section (storage device)

21 input/output history

50 output section (output device)

60 control section (control device)

61 speech recognition section

62 response candidate acquiring section

63 sensitive information determining section

64 circumstance determining section

65 response content determining section

1. A control device for controlling an interactive apparatus that is configured to output, in response to content inputted by a user, response content that is generated based on a past input/output history, the control device comprising:
a sensitive information determining section configured to determine whether or not a specific input/output log selected as a candidate for the response content contains sensitive information;
a circumstance determining section configured to determine whether or not a circumstance in which the interactive apparatus is present is a circumstance in which output of the sensitive information is appropriate; and
a response content determining section configured to determine the response content,
the response content determining section being configured to, if the circumstance determining section determines that the circumstance in which the interactive apparatus is present is not a circumstance in which output of the sensitive information is appropriate, determine to use, as the response content, an alternative response that does not contain the sensitive information.

2. The control device according to claim 1, wherein the circumstance determining section is configured to determine whether or not the circumstance in which the interactive apparatus is present is a circumstance in which output of the sensitive information is appropriate based on at least one of a location of the interactive apparatus, an ambient sound around the interactive apparatus, and a current date and time.

3. The control device according to claim 1, wherein the alternative response does not contain any content of the past input/output history.

4. The control device according to claim 1, wherein, if the content inputted by the user and the response content outputted by the interactive apparatus contain the sensitive information, the content inputted by the user and the response content outputted by the interactive apparatus are provided with information indicating that the sensitive information is contained, and are registered as input/output logs in the past input/output history.

5. An interactive apparatus configured to output, in response to content inputted by a user, response content that is generated based on a past input/output history, the interactive apparatus comprising:
at least one input device;
at least one output device;
at least one storage device; and
at least one control device,
the at least one control device being configured to carry out a process comprising
sensitive information determining step comprising determining whether or not a specific input/output log selected as a candidate for the response content contains sensitive information,
a circumstance determining step comprising determining whether or not a circumstance in which the interactive apparatus is present is a circumstance in which output of the sensitive information is appropriate, and
a response content determining step comprising determining the response content,
the response content determining step comprising, if it is determined in the circumstance determining step that the circumstance in which the interactive apparatus is present is not a circumstance in which output of the sensitive information is appropriate, determining to use, as the response content, an alternative response that does not contain the sensitive information.

6. A method of controlling an interactive apparatus that is configured to output, in response to content inputted by a user, response content that is generated based on a past input/output history, the method comprising:
a sensitive information determining step comprising determining whether or not a specific input/output log selected as a candidate for the response content contains sensitive information;
a circumstance determining step comprising determining whether or not a circumstance in which the interactive apparatus is present is a circumstance in which output of the sensitive information is appropriate; and
a response content determining step comprising determining the response content,
the response content determining step comprising, if it is determined in the circumstance determining step that the circumstance in which the interactive apparatus is present is not a circumstance in which output of the sensitive information is appropriate, determining to use, as the response content, an alternative response that does not contain the sensitive information.
